(19) United States
(12) Patent Application Publication
(10) Pub. No.: US 2012/0110862 A1
(43) Pub. Date: May 10, 2012

(54) Marker installation tool

(75) Inventor: Herrick A. Mann, Pepper Pike, OH (US)

(73) Assignee: Land Escaper Products LLC, N. Randall, OH (US)

(21) Appl. No.: 13/317,950

(22) Filed: Nov. 1, 2011

Related U.S. Application Data
(60) Provisional application No. 61/456,238, filed on Nov. 4, 2010.

(51) Int. Cl. G08B 5/00

(52) U.S. Cl. 30/366

(57) ABSTRACT

A method and apparatus of installing markers into a variety of ground conditions is described. Application of marker installation tool provides for complete installation in hard, soft, wet, dry, frozen, and a variety of other ground conditions, whether the marker is rigid or flexible. By inserting a marker into the tool, it can be easily and rapidly driven into the ground. A sharpened end portion on one end of the tool provides for driving a hole into the ground in preparation of installing a marker.

This application claims the benefit and priority of U.S. Provisional Application 61/456,238, filed Nov. 4, 2010, which is incorporated by reference as if fully restated herein.

The present invention relates generally to the field of landscaping, grounds maintenance, gardening, and snow removal and more specifically, to the installation of terrain markers.

### BACKGROUND OF THE INVENTION

Terrain markers traditionally serve various purposes, including use as an anchor or support for other objects such as planters or fencing, use as visual markers such as for identifying property boundaries, or other like purposes. For example, visual markers are commonly used to properly define and protect property during the performance of potentially damaging tasks, such as snow removal. Markers define pavement edges and obstructions, which permit the safe performance of a snow plow or similar apparatus.

Markers typically comprise rods or stakes, and may be constructed with a circular, square, or other cross section, the advantages and disadvantages of each being well known to one of ordinary skill in the art. Markers may be made from a variety of materials such as wood or metal, the constraining factor being sufficient rigidity such that a marker may be easily driven into the ground with the aid of a hammer or similar tool.

Newer markers utilize modern materials, such as fiberglass, which combine strength with flexibility. Flexibility is a desired advantage, as a marker that flexes under force is less damaging to objects that may come into contact with it. For example, markers used to define a driveway are in an area of high vehicle traffic, and rigid posts can represent a significant impact risk to cars, whereas a flexible marker would bend, and cause limited or negligible damage to a vehicle. Additionally, flexible markers are less likely to be damaged themselves, and are less likely, therefore, to need replacement or repair. Synthetic materials, such as fiberglass, also do not degrade as a result of environmental exposure. As a result of the above considerations, fiberglass markers are often preferred over rigid markers made from other materials.

Installation of a marker comprises a two-handed operation, with one hand supporting the marker, and the other hand utilizing a hammer or similar tool. While the increased strength and flexibility of fiberglass enables a better performing marker, the same attributes that make the materials preferable also make markers made from them more difficult to install.

A terrain marker comprised of flexible materials has a tendency to flex preventing it from being hammered into the ground using the same method as a rigid rod. Installation of terrain markers comprised of fiberglass results in splintering of fiberglass fibers away from the rod shaft, and can result in slivers of fiberglass that can subsequently harm the installer. Therefore, a method of easily and rapidly installing flexible markers is desired.

Because various situations necessitate a variety of different types of markers, it would be advantageous to develop a tool and method capable of easily and rapidly installing not only flexible markers, but also of installing rigid markers.

Markers also need to be placed in a wide variety of ground conditions, such as soft earth, wet or dry earth, hardened or packed earth, sand, ground covered in snow, or other conditions. Therefore, it is also desirous that a tool and method can be utilized in different environments and ground conditions.

### SUMMARY OF THE INVENTION

The invention described herein provides for a method and apparatus of installing markers. Specifically, the described method and apparatus enable a user to install a marker regardless of flexibility or material, in a controlled manner, at a desired angle and depth, in a wide variety of ground conditions. The tool also minimizes the effort required by the installer, and increases the rate at which markers may be installed.

The descriptions found herein are included for the purposes of illustration only, and should not be seen to limit the scope of the invention to any specific embodiment. Discussion of the preferred use of different embodiments is done by way of suggestion, and should not indicate that the invention cannot be utilized in other ways, or modified to be used in different ways, to the extent that such use or modification would be comprehended or recognized by one of ordinary skill in the art.

As will be evident through further description herein, in some embodiments, the invention comprises a mechanical tool comprising a shaft portion, and a sharpened end portion affixed to one end of the shaft portion, and at least one grip member affixed to the exterior of the shaft portion (“Marker Installation Tool” or “MIT”).

In other embodiments, the MIT also comprises a hole on the shaft portion located on the end opposite to the end attached to the end portion, and an interior cavity in communication with the hole.

Additionally, the invention comprises several different methods of application, which, as they may be used in sequence or combination, define several different embodiments for the process of the invention.

In a first embodiment of the installation process, the user positions the MIT above the location where a marker is desired to be installed, wherein the sharpened end portion is pointing to the ground. The user drives the sharpened end of the MIT into the ground by applying force to a grip member with a foot. The user then removes the MIT, and installs by hand a marker in a hole created by the vacated sharpened end portion.

In a second embodiment of the installation process, the user inserts a marker into the interior cavity of the MIT by passing it through the hole. The user then positions the MIT in the location where a marker is desired to be installed, wherein an end of the marker, extending beyond the hole in the shaft portion, is pointing to the ground. The user drives the end of the marker into the ground by applying force to a grip member with a foot. The user then removes the MIT, leaving the marker installed in the desired location.

In yet another embodiment, the user creates a hole in the ground at the desired location using the sharpened end portion in a manner similar to the first embodiment of the process described above, and then subsequently inserts a marker into the MIT and installs the marker by placing the end of the marker extending beyond the hole in the shaft portion into the hole in the ground created by the sharpened end portion, and installs the marker in a manner similar to the second embodiment described above.

It should be understood that several different embodiments of the process described above may be used in sequence or in combination, as would be determined by one of ordinary skill in the art based upon relevant factors such as the ground condition, the environmental conditions, and other factors. For example, a MIT may be used to create a hole in the ground, and the user may install a rigid marker with the aid of a hammer or other tool. A specific advantage of such a process would be that the user need only use one hand for the installation, as the hole would be deep enough to keep the rigid member in place.

### BRIEF DESCRIPTION OF THE FIGURES

The application, construction, and advantages of the invention are better understood by reference to several accompanying figures, which are included for the purposes of illustration. The disclosure herein should not be read to limit the scope of the invention to a specific embodiment as depicted in the attached figures.

FIG. 1 depicts a perspective view of one embodiment of a MIT.

FIG. 2 depicts a perspective detail view of the MIT as depicted in FIG. 1, highlighting a marker hole and interior cavity.

FIG. 3 depicts a perspective detail view of the MIT as depicted in FIG. 1, highlighting a sharpened end portion.

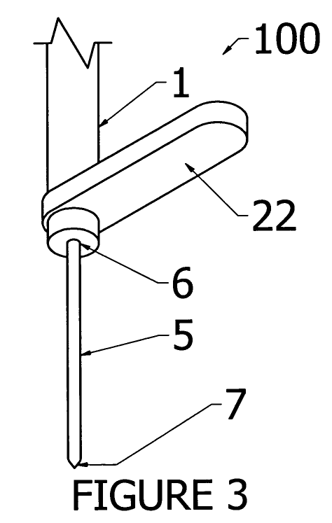

### DETAILED DESCRIPTION OF THE INVENTION

In the following description, words like approximately, opposite, sufficient, and the like should be construed to have the broadest permissible meaning.

MITs have a wide application of use, and their application, construction, and advantages can be better understood through the illustrative description of several examples of use.

In some instances, the user would be desirous of installing a marker constructed using a flexible material. This decision may be based on the ground condition, intended use, or other factors. With known means, installing a flexible marker would be laborious or difficult, and the traditional application with a hammer or like tool may actually damage the marker, or create injury to the user. Conversely, a user, by use of a MIT, may quickly, easily, and safely install flexible markers.

While the use contemplated herein describes the installation of flexible markers, it should be understood that the use of a MIT can also be advantageous when installing rigid markers. Traditional installation requires both hands, while as will be illustrated in more detail below, application of the MIT only requires one hand operation.

Therefore, it should be understood that the application can be applied to a wide variety of marker types and materials.

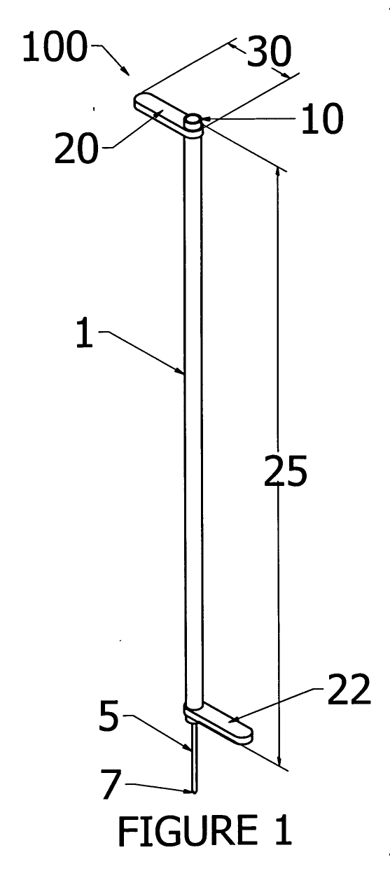

The attached figures describe one embodiment of a MIT, but many different embodiments comprise similar features. Therefore, while a specific embodiment may not include every feature described in the figures, the numbering convention found therein persists across all embodiments. For example, FIG. 1 includes a shaft portion 1, a sharpened end portion 5, and a hole 10. In one embodiment, a MIT may be described having a shaft portion 1, and a hole 10, and not having an sharpened end portion 5, while a second embodiment might describe a MIT having a shaft portion 1 and a sharpened end portion 5, while not having a hole 10.

The embodiments described herein are included for the purposes of illustration. Other embodiments may include features in common with one or more of the embodiments included below, and the scope of the invention should not be construed to be limited to following specific examples.

A first embodiment of a MIT 100 comprises a shaft portion 1, a hole 10 located at one end of the shaft portion 1, the hole being in communication with an interior cavity 15 of the shaft portion 1, and a grip member 20 affixed to the shaft portion 1 in a location proximate to the hole 10.

The shaft 1 as depicted in FIG. 1 is a primarily cylindrical tube, although it should be understood that different shapes and cross-sections would be similarly applicable for use in the invention. The shaft 1 may be constructed out of a hardened metal in order to create a device of sufficient durability to withstand continued use, although it should be understood that other materials may be similarly adopted. The shaft has a first length 25, which in a typical embodiment may be approximately 2 feet, although other lengths would have similar construction, and may also be adapted to other uses.

Since the size of the interior cavity, and therefore the length available for a marker to be inserted, is in direct proportion to the first length 25, a longer first length may provide for the installation of larger markers, and a smaller first length may provide for the installation of smaller markers.

In the present embodiment, the shaft 1 is a singular cylindrical tube. In other embodiments, the shaft 1 may be comprised of multiple sections which are either permanently attached together or capable of being detached, collapsed, or reconfigured by a user.

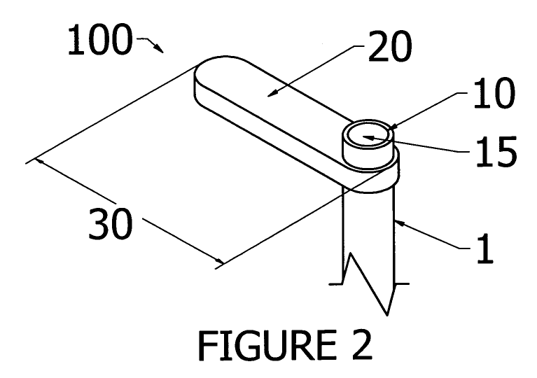

The hole 10, as depicted in FIG. 2, is sized such that a marker may be inserted into the interior cavity 15. Markers may come in different sizes, so the sizing of the hole may be selected by one of ordinary skill in the art in order to facilitate a particular marker. However, it should be understood that a precise close fit between hole size and marker diameter is not necessary, as even a loose fit provides sufficient support to allow the installation of a marker.

The grip member 20, as depicted in FIG. 1, is a linear shaft that extends radially from the shaft portion 1 from a location proximate to the hole 10. This location allows the user to drive the installation of the marker into the ground by exerting force on the grip member 20. The grip member 20 has a second length 30, which is sufficiently long to allow for the placement of a hand or foot. In the present embodiment, the second length is approximately 4 inches.

In the present embodiment, the grip member 20 is a hardened metal of a similar material to the shaft portion, although it should be understood that other materials could be similarly adopted. Similarly, while the present embodiment depicts the grip member 20 as extending radially from the shaft portion 1 such that the grip member 20 is perpendicular to the first length 25, it should be understood that the grip member 20 may extend from the shaft portion 1 such that it creates a different angle with the first length 25. Additionally, the grip member 20, instead of being a linear shaft, may have a different shape or cross section. The reasons behind such configurations may include ergonomic benefit, aesthetic considerations, or other considerations.

In the present embodiment, the grip member 20 is affixed to the shaft portion 1 through welding, although it should be understood that other means of attachment could be utilized. For instance, the grip member 20 may be attached utilizing pivots, hinges, or sliding mechanisms such that the members may be repositioned by a user or placed into a compact shape for storage. Grip members may additionally be comprised of multiple section or pieces to permit complex actions such as folding or reconfiguration by a user, or comprise additional features such as padding.

As depicted by FIG. 1, the present embodiment also comprises an additional grip member 22 proximate to the end of the shaft portion opposite the hole 10. Such a second grip member 22, has structure and features similar to the grip member 20, and provides for a place for the user to grasp the MIT with a hand during installation of a marker, rather than having the user grasping the shaft portion.

It should, however, be understood that having a second grip member 22 is not necessary for a successful application of a MIT, and as such, some embodiments of a MIT omit a second grip member 22. Additionally, the addition of yet more additional grip members may be advantageous for reasons contemplated by ones of ordinary skill in the art. These additional grip members may have various configurations, features, and attachment mechanisms, but that such inclusion would not materially alter the primary functionality of the MIT.

A second embodiment of a MIT 100 comprises a shaft portion 1, a grip member 22, and a sharpened end portion 5.

Different grip members may have different lengths and sizes as would be appropriate determined by one of ordinary skill in the art.

As depicted in FIG. 1, the sharpened end portion is a spike, affixed to the end of the shaft portion 1 such that root of the spike 6 is in communication with the end of the shaft 1, and the tip of the spike 7 extends away from the root such that the spike is parallel with the first length 25.

The sharpened end portion 5 is of sufficient length such that, when used to drive a hole in the ground, the resulting hole would be sized such as to accept the installation of a marker. In the present embodiment, the sharpened end portion 5 is approximately 6 inches long, from root 6 to tip 7, and has a root diameter of approximately ¼ inch, although it should be understood that different sizes may be similarly adopted.

In the present embodiment, the sharpened end portion 5 is constructed from a hardened metal, although it should be contemplated that other materials may be similarly adopted. The selected material, however, must be of sufficient durability to withstand deformation when being subjected to the forces required to drive the sharpened end portion into a wide variety of ground conditions, such as, for example hardened, packed or frozen earth.

As in the previous embodiment, the present embodiment comprises an additional grip member 20, while other embodiments may omit such an addition, or comprise yet additional grip members.

As should be understood by one of ordinary skill in the art, the two embodiments described above are not mutually exclusive. However, inclusion of both elements in a single apparatus has synergistic benefits. As will be described in more detail below, the primary functionality of the two embodiments above may be used in sequence or combination so as to provide for the installation of markers under a wide variety of circumstances. As such, FIG. 1 depicts a third embodiment of a MIT with a sharpened end portion 5 as well as a hole 10, a grip member 20, and a grip member 22.

The embodiments describe above have a wide variety of ways in which they may be used. As such, a more complete understanding of the use of the invention can be achieved through the following description of several illustrative methods of using a MIT 100 to install a marker.

A first embodiment of the installation of a marker using a MIT 100 comprises the following steps. First, the user selects a location for the marker. The user then inserts a marker into the hole 10 such that a portion of the marker occupies the interior cavity 15. The MIT 100 is then oriented so that an exposed portion of the marker is pointed toward the ground, and the shaft portion 1 is at a desired angle of installation relative to the ground.

While in many cases, the angle of installation may be perpendicular to the ground, or 90 degrees, it should be understood that a different angle may be desirous for a variety of reasons as would be understood by one of ordinary skill in the art.

The user then exerts force on the MIT 100 in order to drive the exposed portion of the marker into the ground down to a desired depth. The force may be exerted upon the MIT by pushing on the shaft portion 1. The force may also be exerted upon the MIT by the user placing a foot on the grip member 22 and pushing downward. The force may also be exerted upon the MIT by the user placing a hand on the grip member 20 or another like grip member, and pushing on the shaft portion 1. Additionally, a combination of the above forces may be used.

The proper depth for installation may vary depending on several factors including the intended purpose of the markers, the ground condition, or other factors. The MIT is then removed.

If desired, the user may exert force on the marker by hand in order to make final adjustments to the installation depth and angle. Such adjustments, if necessary, might still require significantly less labor and time than were the entire installation conducted by hand.

A second embodiment of the installation of a marker using a MIT 100 comprises the following steps. First the user selects a location for the installation of a marker. The user then orients the MIT such that the sharpened end portion is pointing toward the desired location, and the shaft portion is at a desired angle of installation relative to the ground.

While in many cases, the angle of installation may be perpendicular to the ground, or 90 degrees, it should be understood that a different angle may be desirous for a variety of reasons as would be understood by one of ordinary skill in the art.

The user then exerts force on the MIT 100 in order to drive the sharpened end portion 5 into the ground down to a desired depth.

The force may be exerted upon the MIT by pushing on the shaft portion 1. The force may also be exerted upon the MIT by the user placing a foot on the grip member 20 and pushing downward. The force may also be exerted upon the MIT by the user placing a hand on the grip member 22 or another like grip member, and pushing on the shaft portion 1. Additionally, a combination of the above forces may be used.

The user then removes the MIT 100, and inserts a marker into the hole resulting from the removal of the sharpened end portion 5 from the ground.

If desired, the user may exert force on the marker by hand in order to make final adjustments to the installation depth and angle. Such adjustments, if necessary, might still require significantly less labor and time than were the entire installation conducted by hand.

A third embodiment of the installation of a marker using a MIT 100 comprises the following steps.

First the user selects a location for the installation of a marker. The user then orients the MIT such that the sharpened end portion is pointing toward the desired location, and the shaft portion is at a desired angle of installation relative to the ground.

While in many cases, the angle of installation may be perpendicular to the ground, or 90 degrees, it should be understood that a different angle may be desirous for a variety of reasons as would be understood by one of ordinary skill in the art.

The user then exerts force on the MIT 100 in order to drive the sharpened end portion 5 into the ground down to a desired depth. The force may be exerted upon the MIT by pushing on the shaft portion 1. The force may also be exerted upon the MIT by the user placing a foot on the grip member 20 and pushing downward. The force may also be exerted upon the MIT by the user placing a hand on the grip member 22 or another like grip member, and pushing on the shaft portion 1. Additionally, a combination of the above forces may be used.

The user then removes the MIT 100, and inserts a marker into the hole 10, such that a portion of the marker occupies the interior cavity 15. The MIT 100 is then oriented so that an exposed portion of the marker is pointed toward the ground, and the shaft portion 1 is at the angle of installation relative to the ground.

The user then exerts force on the MIT 100 in order to drive the exposed portion of the marker into the hole resulting from the removal of the sharpened end portion, and into the ground down to a desired depth. The force may be exerted upon the MIT by pushing on the shaft portion 1. The force may also be exerted upon the MIT by the user placing a foot on the grip member 22 and pushing downward. The force may also be exerted upon the MIT by the user placing a hand on the grip member 20, or another like grip member, and pushing on the shaft portion 1. Additionally, a combination of the above forces may be used.

The proper depth for installation may vary depending on several factors including the intended purpose of the markers, the ground condition, or other factors. The MIT is then removed.

If desired, the user may exert force on the marker by hand in order to make final adjustments to the installation depth and angle. Such adjustments, if necessary, might still require significantly less labor and time than were the entire installation conducted by hand.

Different features of the described embodiments may be suited for different purposes, as one of ordinary skill in the art would determine based on factors such as ground condition, environmental conditions, or other factors.

For example, when dealing with hard, packed, or frozen earth, the force created by pressing a marker inserted into the ground using, for example, the third embodiment of a method of installation as described above may not provide sufficient force to drive the marker in the solid ground. Using the sharpened end portion, such as in, for example, the second or third embodiments of the installation process, may create a hole that breaks through the solid ground, and easily and quickly provides for the installation of a marker in what would otherwise be a difficult and time consuming endeavor.

The figures, descriptions, and embodiments disclosed herein are included for the purposes of illustration only. One of ordinary skill in the art may perceive obvious modifications or additions in order to accommodate for user comfort, performance, weight, durability, cost, size, storage, ease of use, or other factors, but, as such modifications or additions would be obvious to one of ordinary skill, they should be deemed to be within the scope of the present invention.

Having thus described the invention, what is claimed as new and desired to be secured as Letters Patent is as follows:

1. A marker installation tool comprising a shaft portion, a marker hole at a first end of the shaft portion in communication with an interior cavity, and at least one grip member, wherein:
the marker hole is sized to allow a marker to pass therethrough;
the interior cavity is of sufficient length such that a substantial portion of a marker can be placed therein; and
a first grip member has a first length of sufficient size to allow the placement and exertion of force of a human hand or foot, and is affixed to a surface of the shaft portion at a location proximate to the first end, the grip member extending radially from the shaft portion.

2. The marker installation tool of claim 1, wherein a second grip member has a second length of sufficient size to allow the placement and exertion of force of a human hand or foot, and is affixed to the surface of the shaft portion at a location proximate to a second end of the shaft portion opposite the first end.

3. The marker installation tool of claim 1, wherein any grip members are affixed to the surface of the shaft portion by means of welding, pivots, hinges, slides, pegs, screws, snaps, other means, or a combination thereof.

4. The marker installation tool of claim 1, wherein the tool is constructed from metal, plastic, wood, fiberglass, or a combination thereof.

5. The marker installation tool of claim 1, wherein the shaft portion is comprised of multiple segments that may be removably attached or collapsed.

6. A marker installation tool comprising a shaft portion, a sharpened end portion affixed to a first end of the shaft portion, and at least one grip member, wherein:
the sharpened end portion is of a sufficient size and length such that insertion into the ground and removal would create a hole sized to allow a marker to be passed therethrough; and
a first grip member has a first length of sufficient size to allow the placement and exertion of force of a human hand or foot, and is affixed to a surface of the shaft portion at a location proximate to a second end of the shaft portion opposite the first end, the grip member extending radially from the shaft portion.

7. The marker installation tool of claim 6, wherein a second grip member has a second length of sufficient size to allow the placement and exertion of force of a human hand or foot, and is affixed to the surface of the shaft portion at a location proximate to the first end.

8. The marker installation tool of claim 6, wherein any grip members are affixed to the surface of the shaft portion by means of welding, pivots, hinges, slides, pegs, screws, snaps, other means, or a combination thereof.

9. The marker installation tool of claim 6, wherein the tool is constructed from metal, plastic, wood, fiberglass, or a combination thereof.

10. The marker installation tool of claim 6, further comprising a marker hole at a second end of the shaft portion in communication with an interior cavity, wherein:
the marker hole is sized to allow a marker to pass therethrough; and
the interior cavity is of sufficient length such that a substantial portion of a marker can be placed therein.

11. The marker installation tool of claim 6, wherein the shaft portion is comprised of multiple segments that may be removably attached or collapsed.

12. A method of using a marker installation tool, the method comprising the steps of:
selecting a location for the installation of a marker;
inserting the marker into a marker hole located on a first end of a shaft portion of the marker installation tool;
orienting the marker installation tool such that the first end is pointing toward the ground at the installation location, and the shaft portion is at a desired installation angle relative to the ground; and
driving an exposed portion of the marker into the ground down to a desired installation depth; and
removing the marker installation tool.

13. The method of claim 12, wherein the driving of the exposed portion of the marker into the ground is achieved by means of the user's exertion of force upon a first grip member affixed to a surface of the shaft portion at a location proximate to the first end, a second grip member affixed to the surface of the shaft portion at a location proximate to a second end of the shaft portion opposite the first end, the shaft portion, or a combination thereof.

14. The method of claim 12, wherein the step of removing the marker installation tool further comprises collapsing any grip members, collapsing the shaft portion, or any other task in preparation of storage of the marker installation tool, or a combination thereof.

15. A method of using a marker installation tool, the method comprising the steps of:
selecting a location for the installation of a marker;
orienting the marker installation tool such that a sharpened end portion affixed to a first end of a shaft portion of the marker installation tool is pointing toward the installation location, and the shaft portion is at a desired installation angle relative to the ground;
driving the sharpened end portion into the ground down to a desired hole depth;
removing the marker installation tool; and
inserting a marker into a ground hole created by the vacated sharpened end portion.

16. The method of claim 15, wherein the driving of the sharpened end portion into the ground is achieved by means of the user's exertion of force upon a first grip member affixed to a surface of the shaft portion at a location proximate to the first end, a second grip member affixed to the surface of the shaft portion at a location proximate to a second end of the shaft portion opposite the first end, the shaft portion, or a combination thereof.

17. The method of claim 15, wherein the step of removing the marker installation tool further comprises collapsing any grip members, collapsing the shaft portion, or any other task in preparation of storage of the marker installation tool, or a combination thereof.

18. The method of claim 15, wherein the step of inserting a marker into the ground hole further comprises the step of the user adjusting an installation depth or installation angle of the marker, or both.

19. The method of claim 15, wherein the step of inserting a marker into the ground hole further comprises the steps of:
inserting the marker into a marker hole located on a second end of a shaft portion of the marker installation tool;
orienting the marker installation tool such that the second end is pointing toward the ground at the installation location, and the shaft portion is at the installation angle relative to the ground;
driving an exposed portion of the marker into the ground hole down to a desired installation depth, wherein the driving of the exposed portion of the marker into the ground is achieved by means of the user's exertion of force upon the first grip member, the second grip member, the shaft portion, or a combination thereof; and
removing the marker installation tool.

20. The method of claim 19, wherein the step of removing the marker installation tool further comprises collapsing any grip members, collapsing the shaft portion, or any other task in preparation of storage of the marker installation tool, or a combination thereof.
